(19) United States
(12) Patent Application Publication
(10) Pub. No.: US 2002/0140647 A1
(43) Pub. Date: Oct. 3, 2002

(54) System and method for a liquid crystal display utilizing a high voltage bias mode

(76) Inventors: Mark Flynn, San Jose, CA (US); Gang Xu, Cupertino, CA (US); Jinsuk Kang, Palo Alto, CA (US)

Correspondence Address: SILICON VALLEY INTELLECTUAL PROPERTY GROUP, P.O. BOX 721120, SAN JOSE, CA, 95172-1120, US

(21) Appl. No.: 09/791,888

(22) Filed: Feb. 21, 2001

(51) Int. Cl. G09G 3/36; G09G 3/32

(52) U.S. Cl. 345/87

(57) ABSTRACT

A method is provided for creating a display. A first and a second surface of a liquid crystal display are positioned such that they face each other. A cell gap is defined between the surfaces. Liquid crystal material is inserted between the pair of surfaces. The cell gap of the display is adjusted for driving a first voltage towards a second voltage for increasing a switching time of the liquid crystal material between on and off states. A display system for generating an image includes a nematic liquid crystal display that has a plurality of pixels. A cell gap is defined between surfaces housing liquid crystal material. A plurality of circuits are each electrically coupled to electrodes of the display to apply a voltage to the liquid crystal material. The cell gap is selected such that a difference between a first voltage and a second voltage is substantially within a predetermined range.

### FIELD OF THE INVENTION

The present invention relates to displays, and more particularly to utilizing high voltage bias to reduce the switching time of a liquid crystal display.

### BACKGROUND OF THE INVENTION

The purpose of an electronic display is to provide the eye with a visual image of certain information. This image may be provided by constructing an image plane composed of an array of picture elements (or pixels) which are independently controlled as to the color and intensity of the light emanating from each pixel. The electronic display is generally distinguished by the characteristic that an electronic signal is transmitted to each pixel to control the light characteristics which determine the pattern of light from the pixel array which forms the image.

A critical parameter in image quality is response time. Except for static images, the information presented on a display changes rapidly over time, typically 60 times a second or faster. Thus a new image is fed into the display every 1/60^{th} of a second, or approximately every 17 ms. Each individual pixel is thus generally required to transition from one state the another in at least this amount of time. For LCDs, this transition is most limited by the response of the liquid crystal material itself. This is a liquid with some viscosity and thus takes time to move from one state to another.

A continuing development effort has been to design LCDs with faster response times, and therefore superior image quality, generally following two parallel paths. First, LC materials with lower viscosities and larger dielectric anisotropies have been produced. Second, since response time increases rapidly with cell gap, LCD designs with thinner cells gaps have been sought.

Liquid Crystal Displays (LCD) typically consist of a layer of nematic liquid crystal composition between a pair of parallel plates, at least one of which is transparent. This technology is employed in a variety of optical installations that are used principally in digital display devices. There are two basic methods for controlling the passage of light through the display.

The first method for controlling passage of light through a display is the twisted nematic liquid crystal display, which is based on the principal of optical activity. The nematic liquid crytal is arranged in a manner to effect a twist, typically of ninety degrees, which causes the light to follow the twist facilitating control of the polorization of light. A good discussion of this early technology can be found in “The optics of Liquid Crystals,” by Henning Wohler and Michael E. Becker published in the Seminar Lecture Notes of The 13^{th} International Display Research Conference of 1993 published by the Society for Information Display (SID). The earliest versions of these displays had very large cell gaps (distance between parallel plates) in the Mauguin range. This lead to very effective polarization control and very slow response time.

In an attempt to address the slow response time, an improvement was created by Gooch and Tarry discussed in the same article disclosing a technique utilizing smaller specific cell gaps with effective polarization characteristics. The thinnest cell gap with faster response time is the first minimum twisted nematic display. This technology is pervasive in the display industry today. However, although much faster than earlier display technology, the response times are still inadequate for the display of multimedia applications as well as even more demanding applications such as those discussed below.

A second method for controlling the polarization in a LCD uses the effect of birefringence. This technique has the effect of modifying the polarization state by introducing a phase shift in the light as it passes through the liquid crystal. This effect is described in “Emerging Liquid Display Technologies,” by Phillip J. Bos published in the Seminar Lecture Notes of SID, Vol. 1, May 18, 1998. While these techniques provided faster response time, they have not been adopted widely in display technology.

With mobile and wireless applications becoming ubiquitous in computing, the need for smaller and smaller displays is critical. With this miniaturization, there is a need to reduce the size of the pixels which comprise the display. The need for such small devices has led to the development of a category of miniature displays often described as microdisplays with pixel sizes as small as 10 microns or less. In order to achieve this pixel resolution, active matrix devices have been developed utilizing silicon wafer fabrication of CMOS devices as opposed to thin-film transistors fabricated on a glass or quartz substrate. Single crystal silicon design rules are many times smaller than used for poly-silicon, resulting in transistor sizes which facilitate microdisplay geometries. With the exception of techniques to separate the single crystal transistors from the silicon substrate utilizing lift-off technology, CMOS based active matrix displays are inherently opaque, and therefore must be reflective rather than transmissive like the poly-silicon devices.

Recent developments in the miniaturization of LCD applications have demanded even faster response times.

There are two technologies in microdisplays that require much faster response times that in large area displays. These large area displays utilize color filters to produce color images. Each pixel is divided into typically three sub-pixels with its own color filter. However, color filter technology cannot produce color filters small enough for use in microdisplays; therefore, many microdisplays use a technique called field sequential color for producing the color images. (reference) Displays that utilize color filters display one image (frame) approximately sixty times every second. This is called the refresh rate. Field sequential color displays display images (sub-frames) at three times this rate, and each of these three images consist of a pure color either Red, Green or Blue producing a full color image. While this produces a high quality image, a refresh rate three times as fast is required and therefore a response time of three times as fast is necessary.

Another application where very high response time is required is digital greyscale which typically utilizes bistable LCDs for microdisplays. In these bistable displays, only the pure white and pure black illumination states are used with various proportions of these states to provide contrasting shades of grey. Similar to the shades of color, this technique typically requires multiple sub-frames per image display necessitating a faster refresh rate and a faster response time. Additionally, when applied to microdisplays, both color and greyscale display technologies may be utilized which further elevates the required response time.

Much of the current miniature display research focuses on the general area of mixed mode, nematic dislays. Mixed mode is a combination of the two physical effects discussed above namely, optical activity and birefringence. This technique puts the twisted nematic below the cell gap required for first minimum and results in a faster response time. However, decreases in the cell gap require correspondingly higher tolerances in the LCD resulting in decreasing yields and higher costs. While manufacturing technologies are improving yields, the costs are increasing which further supports a new display technology with a less costly manufacturing technique. These and other advantages are provided by the display system of the present invention.

### SUMMARY OF THE INVENTION

According to an embodiment of the present invention, a method is provided for creating a display, including a microdisplay. A first and a second surface of a liquid crystal display are positioned such that they face each other. A distance, called a cell gap is defined between the surfaces. A cell gap is defined between the surfaces. Liquid crystal material is inserted between the pair of surfaces.

Each pixel of the display has two states of interest. A first state, the optical on state, emits a maximum amount of light, and is achieved by applying a first voltage to a pixel. A second state, the optical off state, emits a minimum amount of light and is achieved by applying a second voltage to the pixel. The difference between the first voltage and the second voltage is referred to as the swing voltage. The ratio of the luminances of the optical on and optical off state is the contrast ratio. There is a first switching time, referred to as the optical fall time, required to change the state of the pixel from the optical on state to the optical off state. There is a second switching time, referred to as the optical rise time, required to change the state of the pixel from the optical off state to the optical on state. The cell gap of the display is optimized so as decrease the optical rise and fall times. As an option, a layer of compensation film is positioned proximal to one of the surfaces for retarding passage of light therethrough.

The drive scheme of the display can be a digital scheme, an analog scheme, and/or a root mean square scheme among others. As an option, a layer of compensation film is positioned proximal to one of the surfaces for retarding passage of light therethrough. Note that the high and low voltages can vary to produce shades of gray.

According to one embodiment of the present invention, the swing voltage is less than 3.5 volts. Preferably, the swing voltage is less than 2.5 volts.

In another embodiment of the present invention, a contrast ratio of the display is greater than 40:1. In yet another embodiment of the present invention, the sum of the optical rise and fall times is less than 1.5 milliseconds.

According to an embodiment of the present invention, a display system for generating an image includes a nematic liquid crystal display that has a plurality of pixels. A cell gap is defined between surfaces housing liquid crystal material. A plurality of circuits are each electrically coupled to electrodes of the display to apply a voltage to the liquid crystal material. The cell gap is selected such that a difference between a first (low) voltage and a second (high) voltage is substantially within a predetermined range.

In one embodiment of the present invention, a compensation film is positioned proximal to one of the surfaces of the display for retarding passage of light therethrough. Preferably, the compensation film has a retardation value of between about 100 nm and 600 nm. The compensation film reduces the swing voltages. Also preferably, the compensation film is effective for widening a viewing angle of the display and/or increasing a contrast ratio of the pixels.

In another embodiment of the present invention, the cell gap is greater than 1 micron. In yet another embodiment of the present invention, the swing voltage is less than 3.5 volts. Preferably, the swing voltage is less than 2.5 volts.

Accordingly, the present invention provides many advantages over the prior art. Among the advantages provided by the unique methods and systems of the present invention is that sub-millisecond LC response times can be achieved for high color or gray level applications. The swing voltage of the LC drive can be reduced to 2 to 3.5 volts, which is compatible with 0.25 micron Si technology for high logic gate density on the backplane. The requirement of cellgap control is relaxed in the LC cell fabrication for higher yield. The electro-optical performances of the LC cell is improved to achieve high contrast ratio (CR), low swing voltage requirement (ΔV) and high illumination efficiencies.

### BRIEF DESCRIPTION OF THE DRAWINGS

FIG. 1A is a cross sectional view of a reflective display according to an embodiment of the present invention;

FIG. 1B is a diagram of a cross-sectional view of a display system in accordance with a preferred embodiment;

FIG. 2 is a flow diagram of a process for creating a display;

FIG. 3 is a cross sectional view of a reflective display system, wherein the reflective display of FIG. 1 is used in conjunction with a Polarizing Beam Splitter (PBS);

FIG. 4 is a graph illustrating simulated E-O curves for an illustrative embodiment of the present invention set forth in Example 2;

FIG. 5 is a graph depicting simulated E-O curves for an illustrative embodiment of the present invention set forth in Example 3;

FIG. 6 is a graph showing simulated E-O curves for an illustrative embodiment of the present invention set forth in Example 4;

FIG. 7A is a graph illustrating simulated horizontal viewing angle variations for Example 2;

FIG. 7B is a graph depicting simulated vertical viewing angle variations for Example 2;

FIG. 8A is a graph illustrating simulated horizontal viewing angle variations for Example 3;

FIG. 8B is a graph showing simulated vertical viewing angle variations for Example 3;

FIG. 9A is a graph depicting simulated horizontal viewing angle variations for Example 4; and

FIG. 9B is a graph illustrating simulated vertical viewing angle variations for Example 4.

### DESCRIPTION OF THE PREFERRED EMBODIMENTS

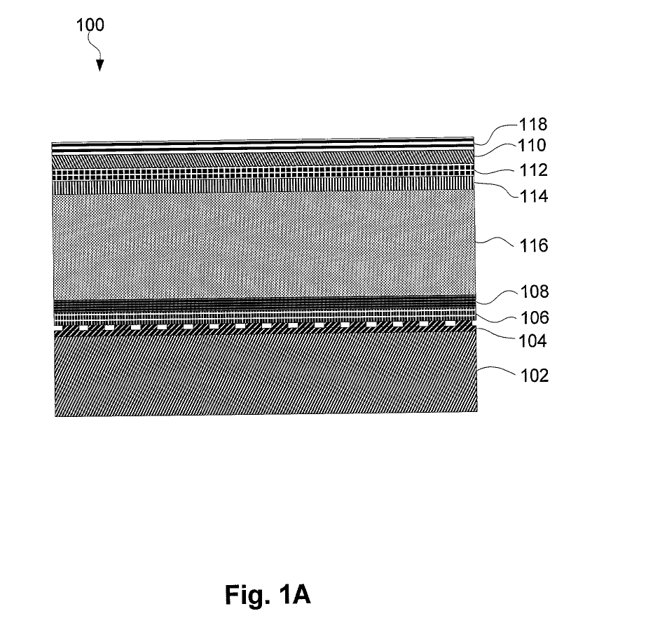

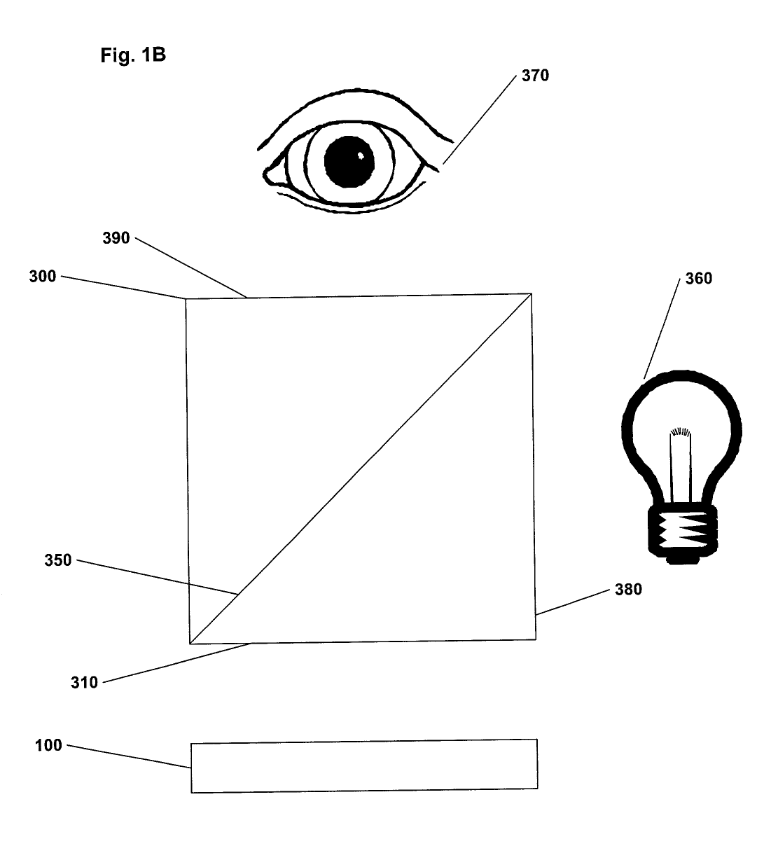

FIG. 1A illustrates a portion of a display 100 according to an illustrative embodiment of the present invention, a liquid crystal display is composed of multiple layers. First, a layer 102 of silicon-based circuitry is coated with a reflective layer 104 preferably constructed of aluminum or other type of reflective substance which acts as an electrode. As an alternative, a layer of transparent metal oxide film can be arranged above a reflective layer. In either case, the layer can be patterned to form the rows and columns of a passive matrix display or the individual pixels of an active matrix display. These electrodes are used to set up the voltage across the cell necessary for the orientation transition. A polymer alignment layer 108 is applied. This layer undergoes a rubbing process which leaves a series of parallel microscopic grooves in the film. These grooves help align the liquid crystal molecules in a preferred direction, with their longitudinal axes parallel to the grooves. This anchors the molecules along the alignment layers and causes the molecules between the alignment layers to twist if desired. A transparent layer 110 is positioned in a spaced relation to the circuitry. A layer 112 of transparent metal oxide film or other conductive substance which acts as an electrode is coupled to the transparent layer. A second alignment layer 114 is applied. Liquid crystal material 116 is inserted between the two sets of layers. Preferably, the transparent layer is coated with a layer of spacers (not shown) to maintain a relatively uniform cellgap between the two layer stacks where the liquid crystal material is eventually placed. In a nematic display, the alignment layers are positioned with their rubbing directions parallel or at an angle to each other and the polarizers are applied to match the orientation of the alignment layers. If necessary, connections are made to the driving circuitry which controls the voltage applied to various areas of the display (pixels). As an option, a layer of retardation film 118 can be applied to the transparent layer (or to layers positioned closer to the bulk of the liquid crystal) to retard transmission of light through it.

FIG. 1B shows a cross sectional view of a display system, wherein the display 100 of FIG. 1A is positioned adjacent to a PBS 300. An illumination source 360 causes light to enter face 380 of the PBS. A layer of thin film coatings 350 causes light in the P polarization state to be reflected through face 310 of the PBS and onto the display 100. The display 100 can then do one of two things. For those pixels which are to be optically on, a first voltage is applied to that pixel. This causes the pixel to reflect light in a P polarization stare. This light enters through face 310 and is transmitted through the thin film coatings 350, and thus out of face 390 and to the viewer. For those pixels which are to be optically off, a second voltage is applied to that pixel. This causes the pixel to reflect light in a S polarization stare. This light enters through face 310 and is reflected from the thin film coatings 350, and thus out of face 380 and away from the viewer. Optical efficiency refers to the amount of light reflected from the display 100 expressed as a percentage of light impinging upon the display.

The embodiments set forth herein are applicable to any type of LC display, such as those found in flat-screen computer monitors, laptop computer displays and flat screen televisions. Such displays may be either transmissive or reflective.

The various embodiments of the present invention set forth herein are adaptable to use in a microdisplay and/or near-eye display. As will be appreciated by those skilled in the art, such displays generally have smaller proportions than displays common to computers and laptop computers. For purposes of illustration only, dimensions of a microdisplay can have dimensions of about 3 inches or less diagonal. Near-eye displays can have dimensions of about 2 inches or less diagonal.

In order to use a digital scheme to drive a nematic LC cell to achieve grayscale and color, a faster LC response time is needed for more gray levels and colors so that a switching between the optical on and off states is completed within a field time. For refresh rate of 60 frames per second with red-green-blue (RGB) sequential color, the sub-frame time is approximately 4 to 6.5 ms. In addition, if digital grayscale is also required, then a further reduction in response time to approximately1 ms is necessary. Prior to this invention, technology has been unable to provide nematic liquid crystal displays with this response time.

For a Normal White (NW) LCD, the optical rise time is determined by the relaxation of the LC directors from the high voltage off state to the low voltage on state. The relaxation time is proportional to the viscosity of the LC material, and inversely proportional to the elastic constant, K, of the LC material, as well as the square of the cellgap. Given a specific LC mode, choosing the LC with low viscosity, high K value and high δn value to reduce the cellgap d, helps to reduce the relaxation time. But we are limited by availability of suitable LC materials, as well as the difficulties of making thin cellgap (<2 micron) LC cell with high yields.

Another factor affecting the relaxation time is bias voltage. High Voltage Bias Mode (HVB Mode) has been explored with nematic LC modulator for optical switching. See I. C. Khoo and S. T. Wu, “Optics and Nonlinear Optics of Liquid Crystals,” (World Scientific, Singapore, 1993), hereinafter referred to as Khoo et al., which is herein incorporated by reference in its entirety, for more information. However, the HVB mode has not been applied to displays.

The relaxation time, t₀, of a LC modulator operated between Vᵢ and Vₚᵢ with undershoot effect has been derived as follows (Eq. 2.104 of Khoo et al.):

$${t}_{0} \approx {( \frac{Δ / π}{2 π} )}^{2} \frac{1}{{( 1 - ζ {V}_{t h} / {V}_{i} )}^{2}} \frac{{γ}_{1} {λ}^{2}}{{K}_{11} δ {n}^{2}}$$

Where Δ is the phase change produced by the LC medium when it is driven at the voltages Vᵢ and V_{π}, ζ a material constant which represents the slope of the voltage-dependent phase change at high voltage regime, λ the wavelength of the light, γ₁ the rotational viscosity, K₁₁ the splay elastic constant and δn the birefringence of the LC material. The undershoot effect refers to a detail of the HBV mode which requires passing through the zero voltage state whenever switching from a high voltage to a low voltage state.

For a reflective device, the phase is switched by π/2. In a display system of the prior art, the liquid crystal is driven between a low voltage which is near zero volts and a phase π/2 and a high voltage with a phase near zero. In accordance with a preferred embodiment, the low voltage is biased by a preset voltage so that the liquid crystal is not required to relax to the low voltage state of the prior art display. This is accomplished by selecting a cell gap such that the zero volt phase is substantially larger than π/2. In accordance with a preferred embodiment, this biased voltage will be referred to as the bias voltage.

In accordance with a preferred embodiment, the following parameter sets (for MLC-6080 liquid crystal material, manufactured by Merck & Co. and sold by EM Industries, Inc., 7 Skyline Drive, Hawthorne, N.Y. 10532) are selected for a display system:

ζ=0.6, Vₜₕ=1.2v, Vᵢ=4.8vγ₁=133 cp, K₁₁=13E-12 J/m, λ=0.6E-6 m, and δn=0.20

and the relaxation time is found to be 0.86 ms. This result is essentially independent of the cellgap as explained in Khoo et al. In accordance with a preferred embodiment, the display is driven between a bias voltage and a high voltage state which have phases of π/2 and 0, but the π/2 state is biased away from zero volts.

Most of the applications for LC light modulator require only a narrow viewing cone. However, for near-eye microdisplays, a larger viewing cone (˜±35°) is needed. To widen viewing angle and simultaneously reduce swing voltage, a negative C-type in conjunction with a positive A-type of retardation films can be used. As an alternative to the combined A- and C-plates, the tilted discotic retardation film developed by Fuji, 1285 Hamilton Pkwy, Itasca, Ill. 60142, can also be used. It should be noted that any other optical film combinations that achieve substantially the same effect can be used.

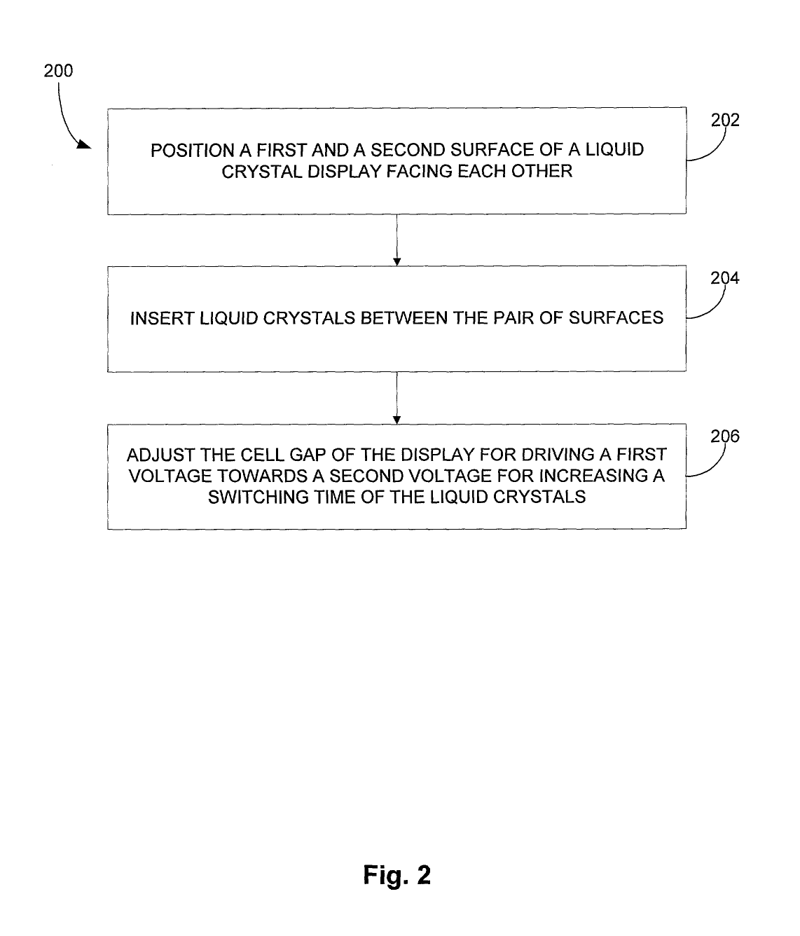

FIG. 2 is a flow diagram of a process 200 for optimizing a display/microdisplay in accordance with a preferred embodiment. In step 202, a first and a second surface of a liquid crystal display are positioned such that they face each other. A cell gap is defined between the surfaces. Liquid crystal material is inserted between the pair of surfaces in step 204. In step 206, the cell gap of the display is adjusted for driving a first (low) voltage towards a second (high) voltage for increasing a switching time of the liquid crystal material between on and off states. The drive scheme of the display can be a digital scheme, an analog scheme, and/or a root mean square scheme. As an option, a layer of compensation film is positioned proximal to one of the surfaces for retarding passage of light therethrough. Note that the low and high voltages do not necessarily have to represent voltages associated with on/off states of the liquid crystal material. Rather, the low and high voltages can be manipulated to other values to produce shades of gray.

According to one embodiment of the present invention, a difference between the first voltage and the second voltage is less than 3.5 volts. Preferably, the difference between the first voltage and the second voltage is less than 2.5 volts.

In another embodiment of the present invention, a contrast ratio of the display is greater than 40:1. In another embodiment of the present invention, the optical rise time is less than 1.5 milliseconds.

### EXAMPLES

For the following examples, optical efficiency only includes those losses due to the liquid crystal mode and do not include losses due to other system components such as the polarizing beam splitters, mirror reflectivity or the surface reflections. The requirements for new LC modes have been selected as follows:

ΔV<=3.3v,

CR>=50:1

Optical efficiency>=80%,

Optical rise time<1.5 ms

The following examples are meant to illustrate various ways that LC cells can be designed to meet the requirements utilizing the methodology of the present invention. They are presented to illustrate various illustrative embodiments of the present invention and should not be considered limiting in any manner.

### Example 1

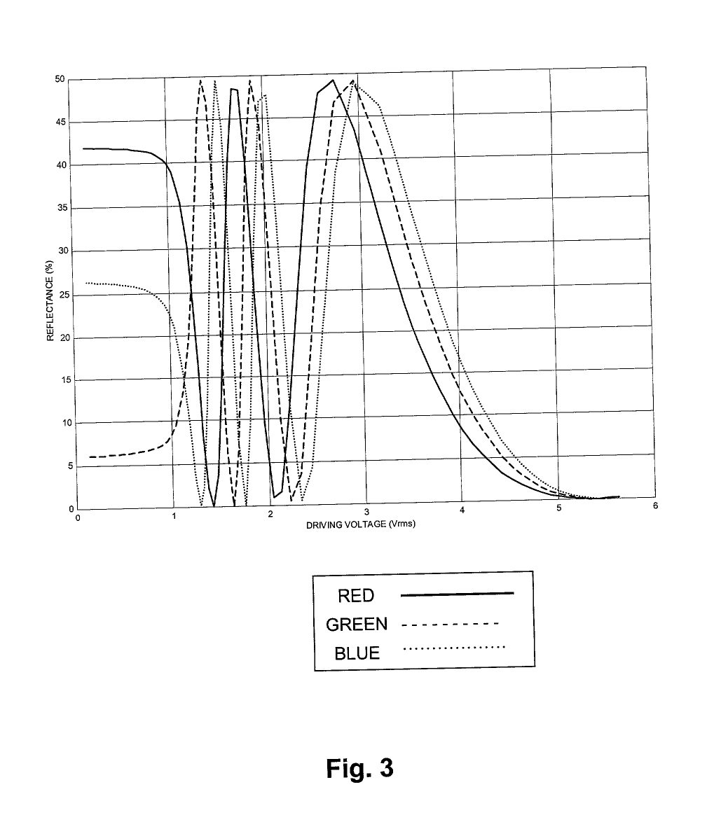

FIG. 3 shows a computer simulation result for a parallel cell. A parallel cell refers to a liquid crystal display in which the liquid crystal molecules are all aligned parallel in the zero voltage state. This display has the following cell parameters:

d=5 microns,

LC=MLC-5300-100,

δn=0.172

β=45 degrees

where β is the angle between the polarizing axis for the incoming beam and the LC rubbing direction. The compensation film, with a retardation value of +210 nm, is placed with its optical axis perpendicular to the rubbing orientation of the rubbing direction of LC. The calculated result is for normal incident beam with wavelength of 634 nm, 525 nm and 472 nm respectively for R, G and B.

Choosing V_{ON}˜3 volts and V_{OFF}˜5.5 volts, a normally white display is obtained with high CR and optical efficiencies. The swing voltage is about 2.5 volts for G and B and 2.8 volts for R. Using equation 2.104 of Khoo et al., the estimated response time is about 0.76 ms with γ₁=95 cp and δn=0.17 (MLC-5300-100).

The required cellgap uniformity for this design can be found from the differences among the R, G, and B curves. The peak voltages for the G and B curves coincide at V_{ON}˜3.0 volts, and differ from that of the R by about less than 20% relative. At the V_{OFF}˜5.3 volts, the RGB curves achieve their minima together, also indicating good cellgap tolerance in the dark state.

### Example 2

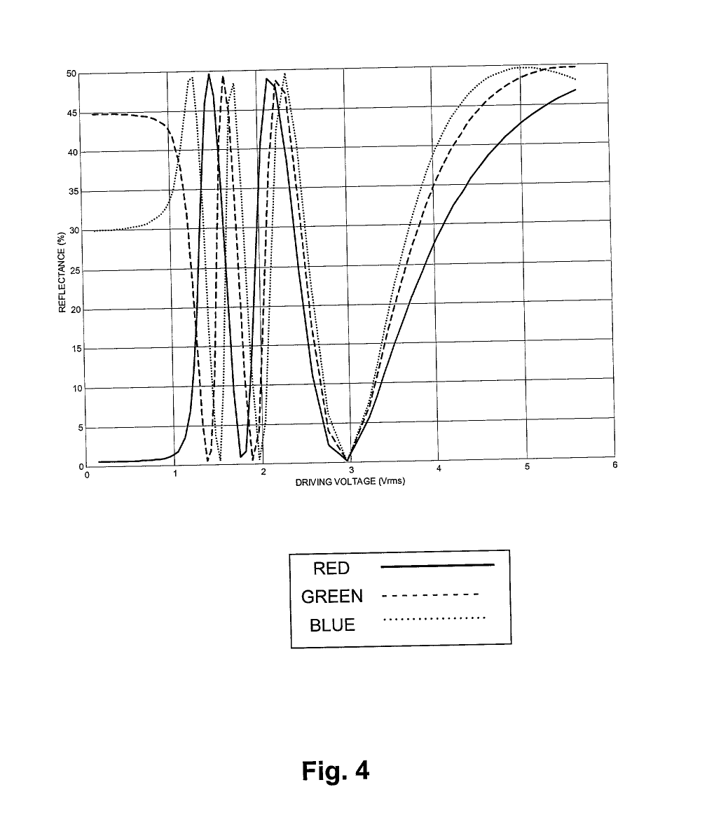

In Example 2, all cell parameters remain the same as that of Example 1, except that the retardation value of the compensation film is changed from +210 nm to +480 nm. This change turns a NW LCD into a Normal Black (NB) one, by choosing V_{OFF} to be around 3 volts and the V_{ON} about 5 or higher. As shown in FIG. 4, it has a voltage swing of about 2.5 volts or less.

As in Example 1, this design has fast response time, good cellgap tolerance, good CR and optical efficiencies.

### Example 3

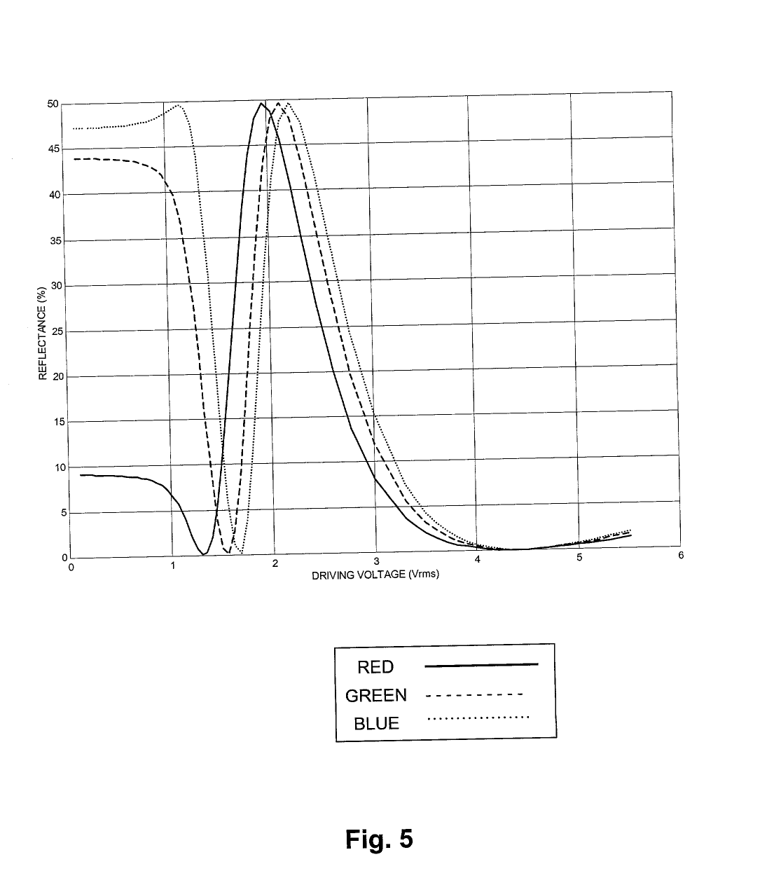

In Example 3, all other parameters remain the same as that of Example 1, except that the cell gap is 2.5 microns and the retardation value of the compensation film is +133 nm. As shown in FIG. 5, it gives a NW, with V_{ON} around 2.2 volts and the V_{OFF} about 4.4 volts. Again, the voltage swing is less than 2.5 volts.

As in Example 1, this design has fast response time, good cellgap tolerance, good CR and optical efficiencies.

### Example 4

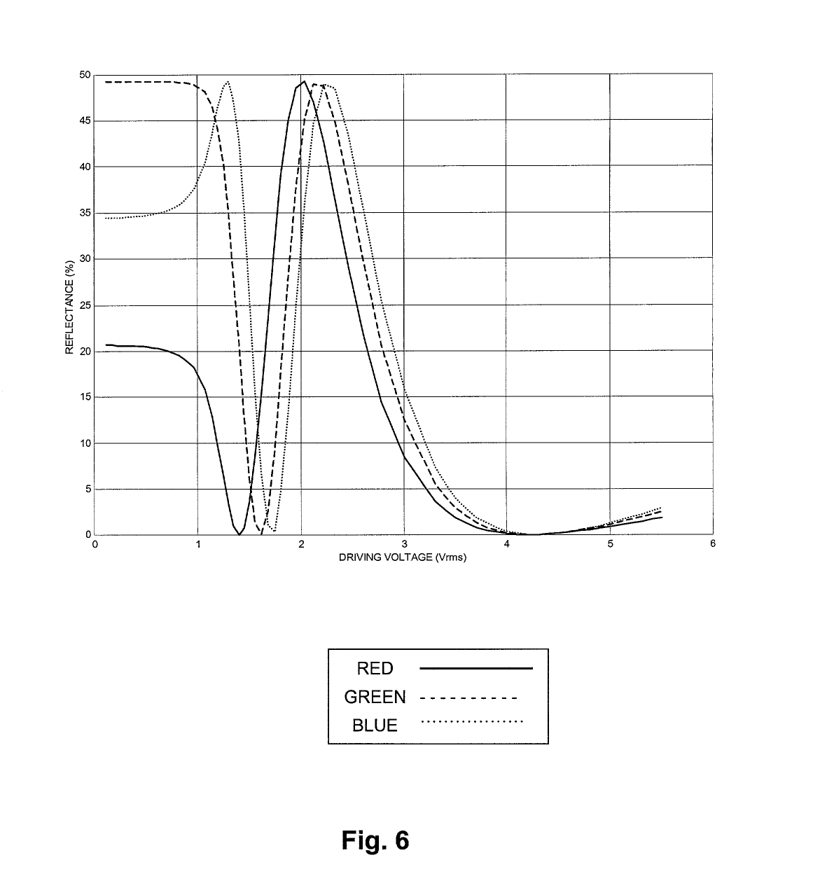

In Example 4, all other parameters remain the same as that of Example 1, except that the cell gap is 2.7 microns. The retardation film is a Sumitomo VAC, which is modeled optically by a combination of an A-type retardation film with retardation value of 149 nm and a C-type film of −186 nm. As shown in FIG. 6, it gives a NW LCD, with V_{ON} around 2.2 volts and the V_{OFF} about 4.2 volts. Again, the voltage swing is less than 2.5 volts.

Like in Example 1, this design has fast response time, good cellgap tolerance, good CR and optical efficiencies.

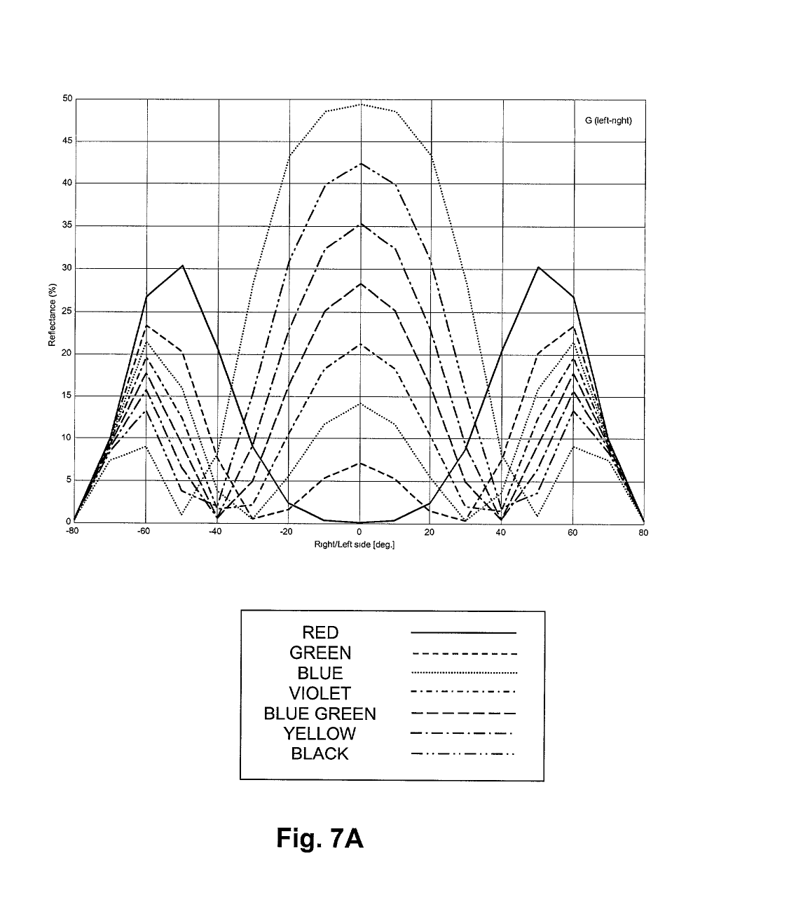

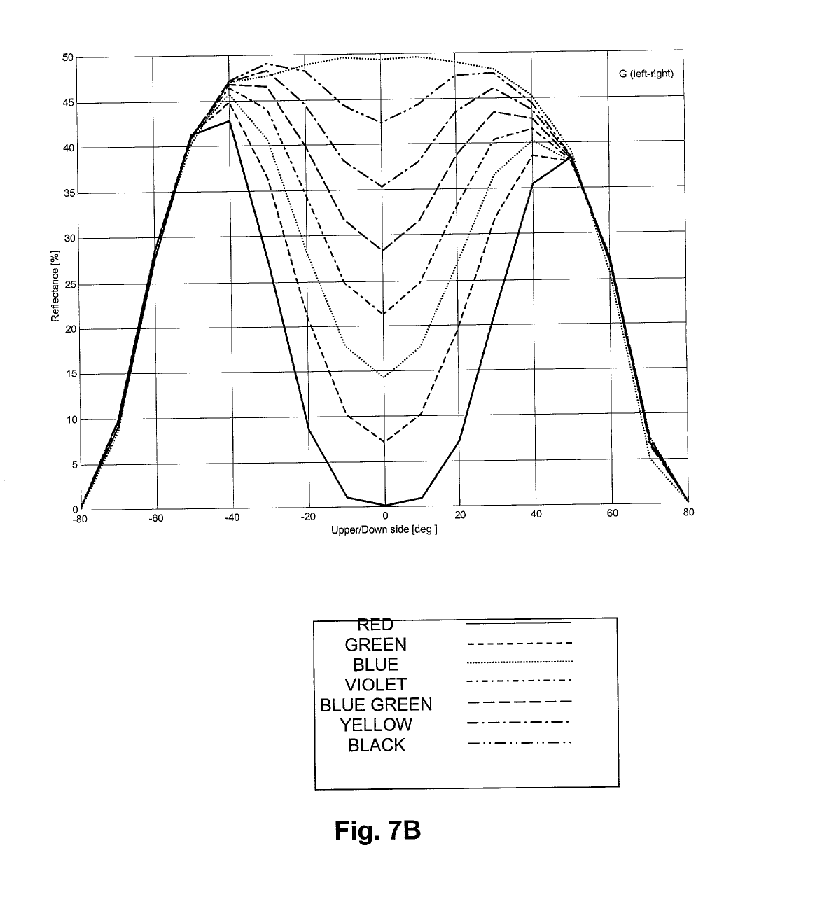

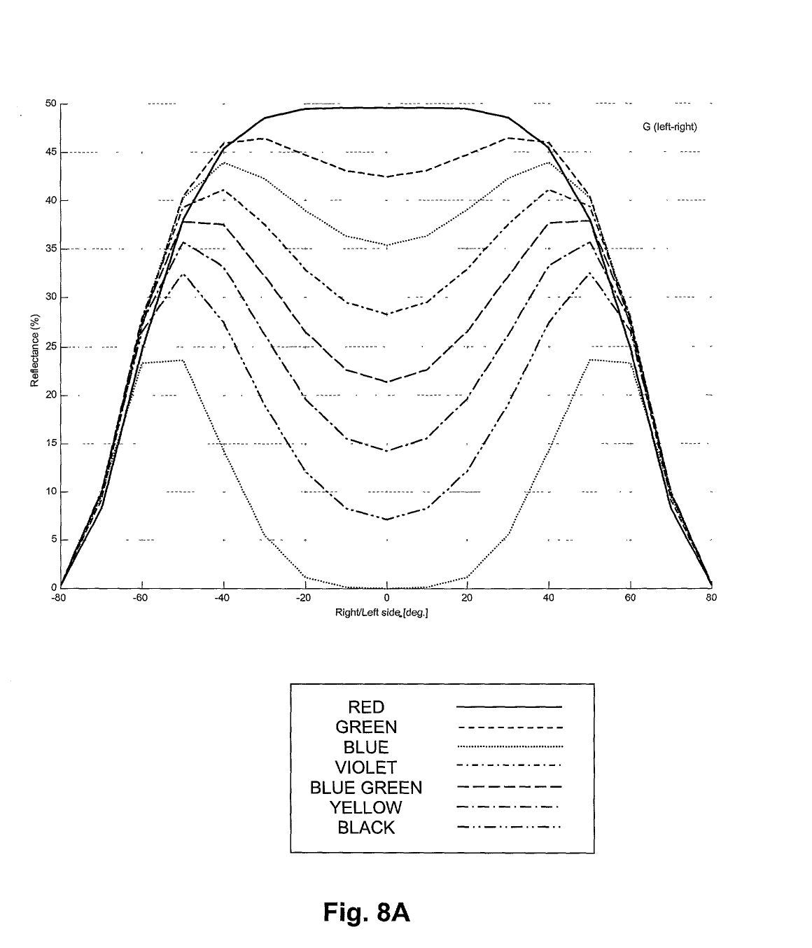

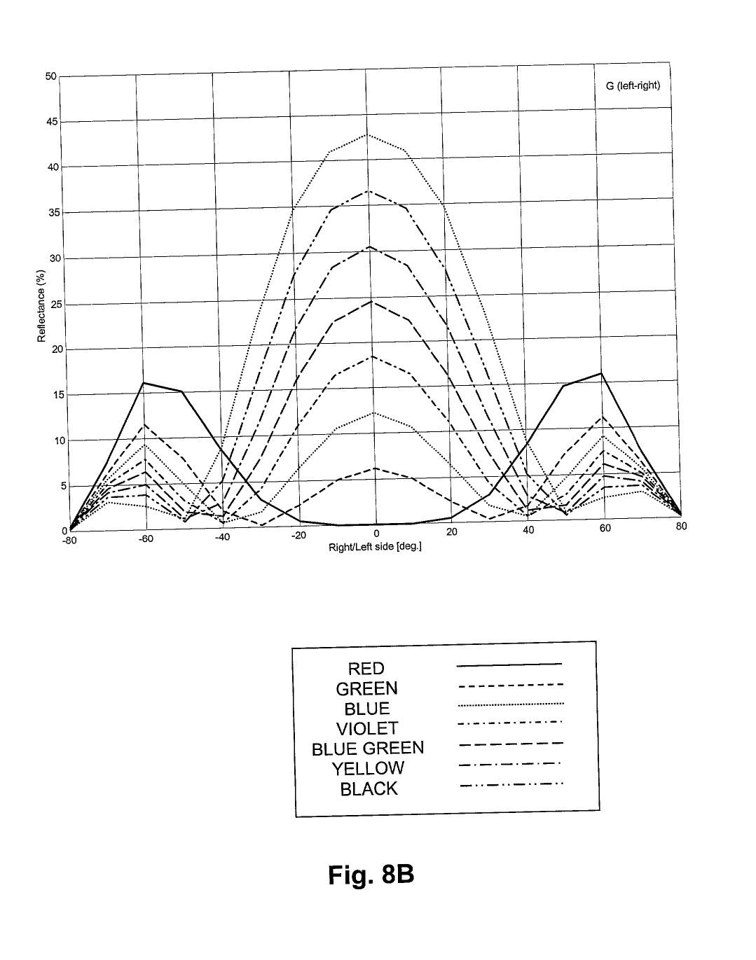

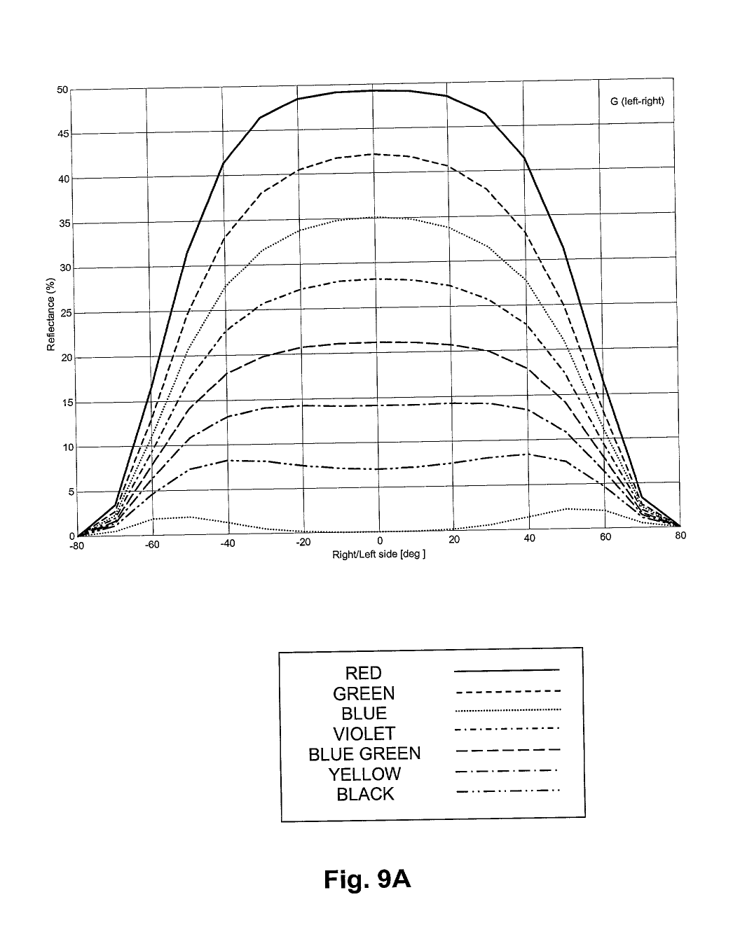

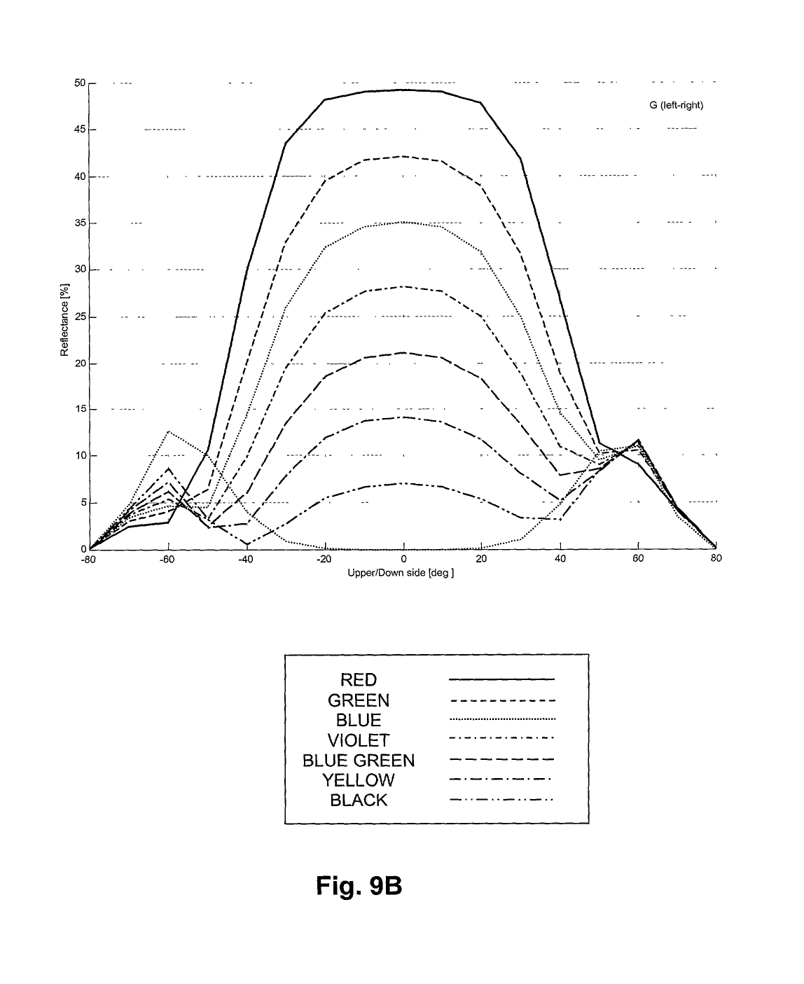

Simulated viewing angle variations of Example 2, 3 and 4 are summarized in FIGS. 7 to 9. Comparing FIGS. 7 and 8, we see that thinner cells are preferred because they have less viewing angle variation. Comparison of FIGS. 8 and 9 shows that the addition of C-type negative components in the retardation films improves the viewing angle performance.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for creating a display, comprising:
(a) positioning a first and a second surface of a liquid crystal display facing each other, wherein a cell gap is defined between the surfaces;
(b) inserting liquid crystal material between the pair of surfaces; and
(c) adjusting the cell gap of the display for driving a first voltage towards a second voltage for increasing a switching time of the liquid crystal material.

2. The method as recited in claim 1, further comprising positioning at least one layer of compensation film proximal to one of the surfaces for improving the performance of the display.

3. The method as recited in claim 1, wherein a drive scheme of the display is at least one of a digital scheme, an analog scheme, and a root mean square scheme.

4. The method as recited in claim 1, wherein color is produced in a filtering scheme or a field sequential scheme.

5. The method as recited in claim 1, wherein a difference between the first voltage and the second voltage is less than 3.3 volts.

6. The method as recited in claim 1, wherein the display is a microdisplay.

7. The method as recited in claim 1, wherein a contrast ratio of the display is greater than 40:1.

8. The method as recited in claim 1, wherein a response time for switching between optical on and off states of pixels of the display is less than 1.5 milliseconds.

9. A display system for generating an image, comprising:
(a) a nematic liquid crystal display having a plurality of pixels, wherein a cell gap is defined between surfaces housing liquid crystal material; and
(b) a plurality of circuits each electrically coupled to electrodes of the display for applying a voltage to the liquid crystal material;
(c) wherein the cell gap is selected such that a difference between a first voltage and a second voltage is substantially within a predetermined range.

10. The system as recited in claim 9, further comprising positioning at least one layer of compensation film proximal to one of the surfaces for improving the performance of the display.

11. The system as recited in claim 10, wherein at least one of the compensation films has a retardation value of between 100 nm and 600 nm.

12. The system as recited in claim 10, wherein the compensation films are effective for at least one of widening a viewing angle of the display and increasing a contrast ratio of the pixels.

13. The system as recited in claim 9, wherein the cell gap is greater than 1 micron.

14. The system as recited in claim 9, wherein a difference between the first voltage and the second voltage is less than 3.5 volts.

15. The system as recited in claim 9, wherein a difference between the first voltage and the second voltage is less than 2.5 volts.

16. The system as recited in claim 9, wherein a contrast ratio of the display is greater than 40:1.

17. The system as recited in claim 9, wherein a response time for switching between optical on and off states of the pixels is less than 1.5 millisecond.

18. The method as recited in claim 1, wherein a difference between the first voltage and the second voltage is less than 2.5 volts.
